(19) United States
(12) Patent Application Publication
(10) Pub. No.: US 2014/0354569 A1
(43) Pub. Date: Dec. 4, 2014

(54) MOBILE PHONE CAPABLE OF SEPARATING SCREEN AND CONTROLLING METHOD THEREOF

(71) Applicant: SAMSUNG ELECTRO-MECHANICS CO., LTD., Gyeonggi-Do (KR)

(72) Inventors: Yoon Seok OH, Gyeonggi-Do (KR); Dae Gil YOON, Gyeonggi-Do (KR); Ji Hoon KIM, Gyeonggi-Do (KR); Sang Hyun SIM, Gyeonggi-Do (KR)

(73) Assignee: SAMSUNG ELECTRO-MECHANICS CO., LTD., Gyeonggi-Do (KR)

(21) Appl. No.: 14/291,961

(22) Filed: May 30, 2014

(30) Foreign Application Priority Data
May 31, 2013 (KR) 10-2013-0062915

(51) Int. Cl. G06F 3/0488; G06F 3/041

(52) U.S. Cl. CPC G06F 3/04886; G06F 3/0416
USPC 345/173

(57) ABSTRACT

Embodiments of the invention provide a mobile phone configured to separate a screen. The mobile phone includes a touch screen configured to display an execution screen of a predetermined application thereon and further configured to sense a touch input by a gesture of a user. The mobile phone further includes a touch input processor configured to measure an X-axis line value and a Y-axis line value of a touch region by the touch input and further configured to determine whether the touch input is an input for separating the screen. Further, the mobile phone includes a controller configured to determine a separation axis of the screen and further configured to separate the screen into one or more regions based on the separation axis when the touch input is determined as the input for separating the screen.

### CROSS REFERENCE TO RELATED APPLICATION

This application claims the benefit of and priority under 35 U.S.C. §119 to Korean Patent Application No. KR 10-2013-0062915, entitled “MOBILE PHONE CAPABLE OF SEPARATING SCREEN AND CONTROLLING METHOD THEREOF,” filed on May 31, 2013, which is hereby incorporated by reference in its entirety into this application.

### BACKGROUND

1. Field of the Invention

The present invention relates to a mobile phone capable of separating a screen and a controlling method thereof.

2. Description of the Related Art

Portable terminals provide various functions and services (e.g., online game, chatting, photo shooting, multimedia data transmission, as non-limiting examples) to satisfy requirements of a user. However, it is difficult to support diversified functions of the portable terminal only by a general user interface device based on a key pad. Therefore, in recent years, as a user interface for maximizing convenience of the user and space utilization, a touch type user interface, such as a touch pad or a touch screen for various kinds of user terminals, has been rapidly adopted. The reason is that cost of a touch type interface device is reduced and problems of low reliability and lifespan of the touch type interface devices according to the conventional art are solved by the adaptation of the touch type user interface described above.

Specifically, the touch screen may provide an interactive and immediate response for content output on the screen and content input through the screen to the user, and may provide high user satisfaction and use convenience because it is possible to perform various forms of inputs in various manners. Thus, it is possible to simultaneously perform various types of inputs and outputs as a concept integrating an output device and an input device configuring the user interface as compared to a regular user input device, such as the key pad having a fixed arrangement according to the conventional art. Particularly, in accordance with a change from a conventional text-based interface configured by low resolution numeric and alphanumeric characters to a graphic based interface having high resolution, because it is possible to realize an input through a graphic-based object and a key pad installing area may be omitted in the case in which the key pad is replaced, it is possible to display a relatively large screen in a terminal having the same volume.

Particularly, most of the smart phones, which are rapidly propagated in recent years have the touch screen as the user interface. Representative examples of an operating system of the smart phone may include Android™ of Google' Inc. and iOS™ of Apple, Inc. The user interface is provided by the touch screen having a slightly different form depending on the operating system. However, because one application execution screen is executed by only the entire screen, in the case in which it is intended to view another application screen while executing the one application, there was a need to change from an executing application window to another application window.

Additionally, as described in KR 10-2013-2012-0005153, in order to separate the application execution screen, a method of separating the screen using a touch drag has been used according to the conventional art. In the case in which the screen is separated by the method described above, there is a problem in identifying whether a touch drag operation of the user is a drag for separating a screen or a drag for another operation.

### SUMMARY

Accordingly, embodiments of the invention have been made in an effort to provide a mobile phone configured to separate a screen capable of simply separating a display region of the mobile phone into a plurality of regions by an intuitive gesture of a user, and a controlling method thereof.

According to various embodiments of the invention, there is provided a mobile phone configured to separate a screen. The mobile phone includes a touch screen configured to display an execution screen of a predetermined application thereon and further configured to sense a touch input by a gesture of a user. The mobile phone further includes a touch input processor configured to measure an X-axis line value and a Y-axis line value of a touch region by the touch input and further configured to determine whether the touch input is an input for separating the screen. Further, the mobile phone includes a controller configured to determine a separation axis of the screen and further configured to separate the screen into one or more regions based on the separation axis when the touch input is determined as the input for separating the screen.

According to an embodiment, after the controller separates the screen, the controller is further configured to display the application being displayed before the input for separating the screen in one region among the separated screens and further configured to display at least one other application in the remaining regions.

According to an embodiment, the touch input processor is configured to determine a long side value and a short side value among the X-axis line value and the Y-axis line value and then configured to determine whether or not the long side value exceeds a first reference value.

According to an embodiment, the touch input processor is further configured to determine whether or not the short side value exceeds a second reference value when the long side value exceeds the first reference value.

According to an embodiment, the touch input processor is further configured to determine whether or not the long side value exceeds a third reference value when the short side value exceeds the second reference value, and wherein the third reference value is the short side value * a predetermined coefficient.

According to an embodiment, when the long side value exceeds the third reference value, the controller is configured to separate the screen based on a Y axis as the separation axis when the long side value is the X-axis line value and further configured to separate the screen based on an X axis as the separation axis when the long side value is the Y-axis line value.

According to another embodiment of the invention, there is provided a controlling method of a mobile phone configured to separate a screen. The method includes a gesture recognizing operation of displaying an execution screen of a predetermined application on a touch screen and sensing a touch input by a gesture of a user, and a screen separation determining operation of measuring an X-axis line value and a Y-axis line value of a touch region by the touch input and determining whether the touch input is an input for separating the screen. The method further includes a screen separating operation of determining a separation axis for separating the screen and then separating the screen into one or more regions based on the separation axis when the touch input is determined as the input for separating the screen.

According to an embodiment, the controlling method of the mobile phone configured to separate the screen further includes, after the screen separating operation, displaying the application being displayed before an input for separating the screen in one region among the separated screens and displaying at least one other application in the remaining regions.

According to an embodiment, the screen separation determining operation includes determining a long side value and a short side value among the X-axis line value and the Y-axis line value and then determining whether or not the long side value exceeds a first reference value.

According to an embodiment, the screen separation determining operation further includes determining whether or not the short side value exceeds a second reference value when the long side value exceeds the first reference value.

According to an embodiment, the screen separation determining operation further includes determining whether or not the long side value exceeds a third reference value when the short side value exceeds the second reference value, and the third reference value is the short side value * a predetermined coefficient.

According to an embodiment, the screen separating operation includes separating the screen based on a Y axis as the separation axis when the long side value is the X-axis line value and separating the screen based on an X axis as the separation axis in the case in which the long side value is the Y-axis line value, when the long side value exceeds the third reference value.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram of a mobile phone capable of separating a screen according to an embodiment of the invention.

FIG. 2A is a diagram showing separation of a display region using the whole finger according to an embodiment of the invention.

FIG. 2B is a diagram showing a coordinate of a region touched by the finger in FIG. 2A according to an embodiment of the invention.

FIG. 2C is a diagram showing a display region separated into two regions by the finger in FIG. 2A according to an embodiment of the invention.

FIG. 3A is a diagram showing separation of a display region using a palm side according to an embodiment of the invention.

FIG. 3B is a diagram showing a coordinate of a region touched by the palm side in

FIG. 3A according to an embodiment of the invention.

FIG. 3C is a diagram showing a display region separated into two regions by the palm side in FIG. 3A according to an embodiment of the invention.

FIG. 4 is a flow chart illustrating a controlling method of a mobile phone capable of separating a screen according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

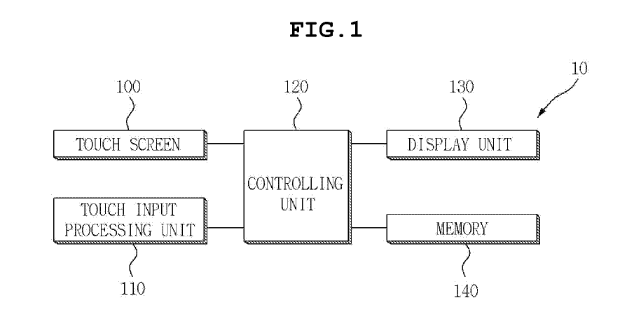

FIG. 1 is a block diagram of a mobile phone capable of separating a screen according to an embodiment of the invention. As shown in FIG. 1, a mobile phone configured to separate a screen, according to an embodiment of the invention, includes a touch screen 100, a touch input processor 110, a controller 120, a display 130, and a memory 140. The mobile phone including the components described above, according to an embodiment of the invention, is a portable communication terminal, such as a smart phone or a tablet PC, as non-limiting examples.

According to an embodiment, the touch screen 100 displays an execution screen of a predetermined application thereon, senses a touch input by a gesture of a user, and provides the touch input to a touch input processor 110. According to at least one embodiment, the touch input by the gesture of the user includes, for example, a touch by the whole single finger, but may also be a touch by a palm side.

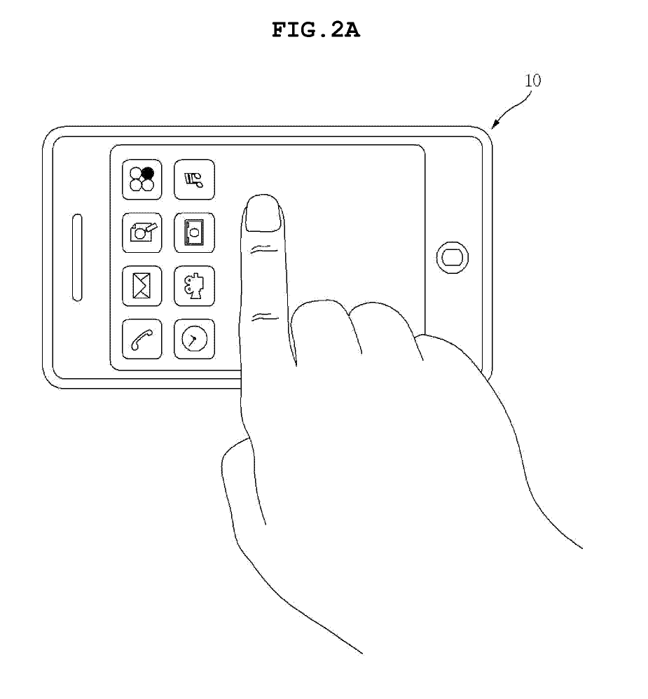

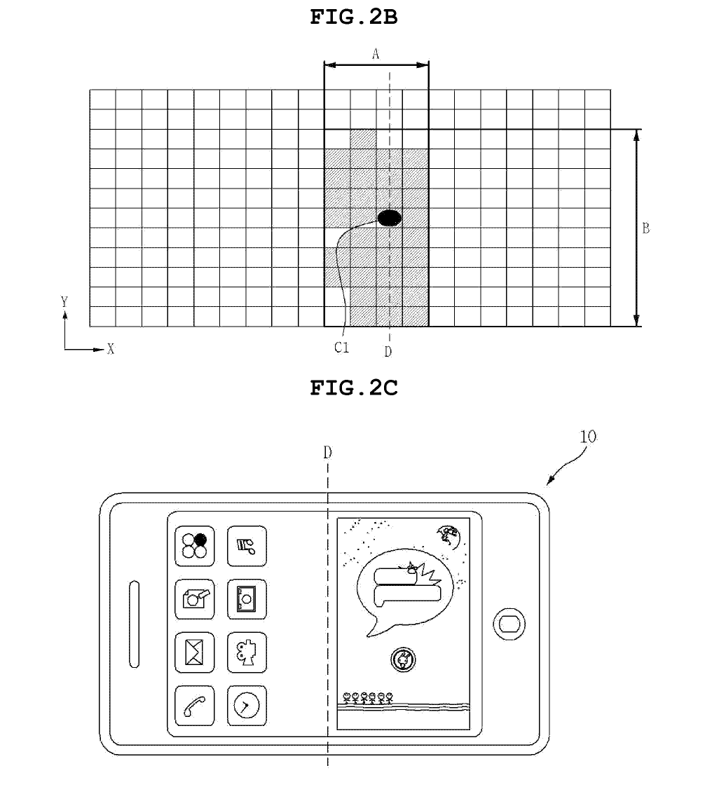

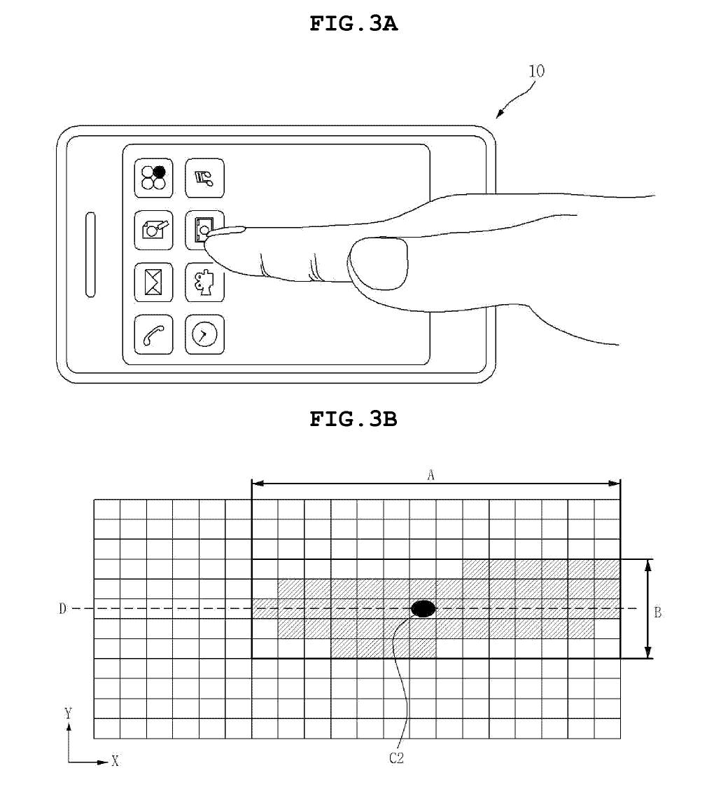

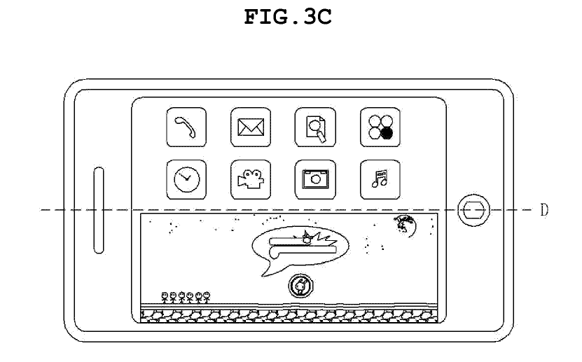

When the touch input processor 110 receives the touch input by the gesture of the user sensed by the touch screen 100, the touch input processor 110 measures an X-axis line value A and a Y-axis line value B of a touch region by the touch input to determine whether or not the touch input is an input for separating the screen. As shown in FIGS. 2B and 3B, the X-axis line value A refers to a width A in an X-axis direction of the touch region formed of the touch input by the gesture of the user and the Y-axis line value B refers to a width B in a Y-axis direction of the touch region.

When the touch input by the gesture of the user is determined to be the input for separating the execution screen, the controller 120 determines a separation axis for separating the execution screen and then separates the execution screen into one or more regions based on the separation axis.

According to an embodiment, the memory 140 stores a program for processing and controlling the controller 120 and performs a function of temporally storing input/output data (for example, a phonebook, a message, a still image, a moving image, as non-limiting examples).

According to an embodiment, the display 130 is adhered to one surface of the touch screen 100. The display 130, which is a display device configured to visually display data on a screen includes, but is not necessarily limited to, a cathode ray tube (CRT), a liquid crystal display (LCD), a plasma display panel (PDP), a light emitting diode (LED), an organic light emitting diode (OLED), as non-limiting examples.

As described above, the mobile phone 10 configured to separate the screen, according to various embodiments of the invention, improves usability of the display region by separating the display region of the mobile phone 10 into a plurality of regions using an intuitive gesture (e.g., the touch by the side of the hand or the whole finger, etc.) of the user unlike an existing touch input.

Hereinafter, a method of separating a screen of a display region and effect through a touch input by an intuitive gesture of a user (the whole finger or the side of the palm) will be described in more detail.

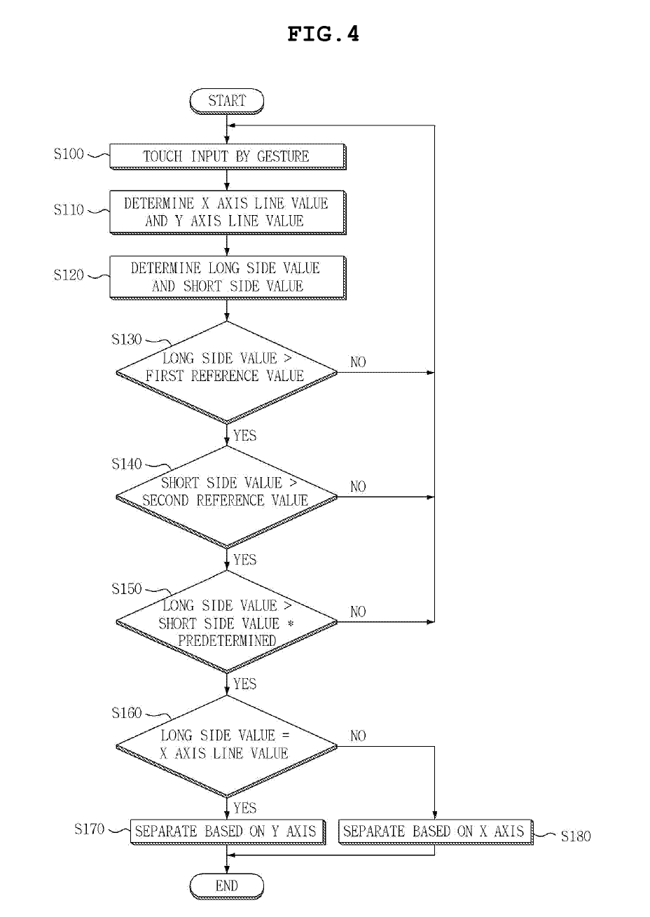

FIGS. 2A to 2C are diagrams showing separation of a display region using the whole finger, FIGS. 3A to 3C are diagrams showing separation of a display region using the palm side, and FIG. 4 is a flow chart illustrating a controlling method of a mobile phone configured to separate a screen, according to various embodiments of the invention.

As shown in FIGS. 2A and 3A, an execution screen of a predetermined application is displayed on the touch screen 100, the user performs a touch input by the gesture (the whole single finger or the palm side), and the touch screen 100 senses the touch input by the gesture of the user and transfers the touch input to the touch input processor 110 (S100).

According to an embodiment, the touch input processor 110 measures the X-axis line value A and the Y-axis line value B of the touch region by the touch input (S110) and then determines a long side value and a short side value among the X-axis line value A and the Y-axis line value B (S120), in order to determine whether or not the touch input is an input for separating the screen. When the gesture of the user is the touch input by the whole single finger, the long side value is the Y-axis line value B and the short side value is the X-axis line value A (see FIG. 2B), and when the gesture of the user is the touch input by the palm side, the long side value is the X-axis line value A and the short side value is the Y-axis line value B (see FIG. 3B).

According to an embodiment, the touch input processor 110 determines whether or not the long side value exceeds a first reference value (e.g., the minimum long side value for getting recognition as an input for separating the screen) (S130) and determines whether or not the short side value exceeds a second reference value (e.g., the minimum short side value for getting recognition as an input for the separating the screen) (S140) when the long side value exceeds the first reference value.

According to an embodiment, when the short side value exceeds the second reference value, the touch input processor 110 determines whether or not the long side value exceeds a third reference value and determines the touch input as the input for separating the screen when the long side value exceeds the third reference value. The third reference value refers to a short side value * a predetermined coefficient (e.g., 2 or 3), and the first reference value to the third reference value is adjusted depending to electrode patterns (not shown) of the touch screen and a device setting.

Next, when the touch input is determined as the input for separating the screen, the controller 120 determines a separation axis D for separating the screen and then separates the screen into one or more regions based on the separation axis D. According to at least one embodiment, the separation axis D is formed in a Y-axis direction passing through a center coordinate C1 when the gesture of the user is input by the whole single finger, as shown in FIG. 2B, and is formed in an X-axis direction passing through a center coordinate C2 when the gesture of the user is input by the palm side, as shown in FIG. 3B. Additionally, when the touch input is performed using the single finger or the palm side of the user, a position at which the screen is separated is adjusted by moving the separation axis D through vertical and horizontal movements when the finger or the palm side is not removed from the touch screen 100.

Thus, as shown in FIGS. 2C and 3C, the controller 120 separates the screen based on a Y axis as the separation axis D when the long side value is the X-axis line value A (S160 and S170) and separates the screen into one or more regions based on an X axis as the separation axis D when the long side value is the Y-axis line value B (S180).

According to an embodiment, although areas of two regions are shown in the same form having a ratio of separated screens of 1:1, various embodiments of the invention are not limited thereto. For example, according to at least one embodiment, two regions have a different ratio. Thus, the touch screen 100 is separated when the ratio of the screen separation is fixed (e.g., 5:5) as well as using the touch coordinate by the touch input of the user.

According to an embodiment, after the screen is separated, the controlling unit 120 may separate the separated screen into one or more regions by again performing the touch input using the single finger or the palm side on the separated screen.

In addition, as shown in FIGS. 2C and 3C, after the screen is separated, the controlling unit 120 display the application being displayed before the input for separating the screen on one region among the separated screens and display at least one other applications on the remaining regions.

According to the embodiment of the present invention, usability of the display region may be improved by separating the display region of the mobile phone into the plurality of regions using the intuitive gesture (e.g., the touch by the side of the hand or the whole finger, etc.) of the user unlike the existing touch input.

In addition, the screen for the at least two applications may be simply provided by the intuitive gesture of the user without the complex menu search, thereby making it possible to maximize convenience of the user using the mobile phone.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A mobile phone configured to separate a screen, the mobile phone comprising:
a touch screen configured to display an execution screen of a predetermined application thereon and further configured to sense a touch input by a gesture of a user;
a touch input processor configured to measure an X-axis line value and a Y-axis line value of a touch region by the touch input and further configured to determine whether the touch input is an input for separating the screen; and
a controller configured to determine a separation axis of the screen and further configured to separate the screen into one or more regions based on the separation axis when the touch input is determined as the input for separating the screen.

2. The mobile phone according to claim 1, wherein after the controller separates the screen, the controller is further configured to display the application being displayed before the input for separating the screen in one region among the separated screens and further configured to display at least one other application in the remaining regions.

3. The mobile phone according to claim 1, wherein the touch input processor is configured to determine a long side value and a short side value among the X-axis line value and the Y-axis line value and then configured to determine whether or not the long side value exceeds a first reference value.

4. The mobile phone according to claim 3, wherein the touch input processor is further configured to determine whether or not the short side value exceeds a second reference value when the long side value exceeds the first reference value.

5. The mobile phone according to claim 4, wherein the touch input processor is further configured to determine whether or not the long side value exceeds a third reference value when the short side value exceeds the second reference value, and wherein the third reference value is the short side value * a predetermined coefficient.

6. The mobile phone according to claim 5, wherein, when the long side value exceeds the third reference value, the controller is configured to separate the screen based on a Y axis as the separation axis when the long side value is the X-axis line value and further configured to separate the screen based on an X axis as the separation axis when the long side value is the Y-axis line value.

7. A controlling method of a mobile phone configured to separate a screen, the method comprising:
a gesture recognizing operation of displaying an execution screen of a predetermined application on a touch screen and sensing a touch input by a gesture of a user;
a screen separation determining operation of measuring an X-axis line value and a Y-axis line value of a touch region by the touch input and determining whether the touch input is an input for separating the screen; and
a screen separating operation of determining a separation axis for separating the screen and then separating the screen into one or more regions based on the separation axis when the touch input is determined as the input for separating the screen.

8. The controlling method according to claim 7, further comprising:
after the screen separating operation, displaying the application being displayed before an input for separating the screen in one region among the separated screens and displaying at least one other application in the remaining regions.

9. The controlling method according to claim 7, wherein the screen separation determining operation includes determining a long side value and a short side value among the X-axis line value and the Y-axis line value and then determining whether or not the long side value exceeds a first reference value.

10. The controlling method according to claim 9, wherein the screen separation determining operation further comprises determining whether or not the short side value exceeds a second reference value when the long side value exceeds the first reference value.

11. The controlling method according to claim 10, wherein the screen separation determining operation further comprises determining whether or not the long side value exceeds a third reference value when the short side value exceeds the second reference value, and wherein the third reference value is the short side value * a predetermined coefficient.

12. The controlling method according to claim 11, wherein the screen separating operation includes separating the screen based on a Y axis as the separation axis when the long side value is the X-axis line value and separating the screen based on an X axis as the separation axis in the case in which the long side value is the Y-axis line value, when the long side value exceeds the third reference value.
